(19) United States
(12) Patent Application Publication
(10) Pub. No.: US 2026/0281785 A1
(43) Pub. Date: Sep. 17, 2026

(54) ACTIVE CSI RESOURCES AND ACTIVE PORTS COUNTING FOR NETWORK ENERGY SAVING

(71) Applicant: HUAWEI TECHNOLOGIES CO., LTD., Shenzhen (CN)

(72) Inventors: Louis Madier, Boulogne Billancourt (FR); Ruijie Li, Beijing (CN); Shurong Jiao, Shenzhen (CN); Yidi Xuan, Beijing (CN); Matthew William Webb, Issy Les Moulieaux (FR)

(73) Assignee: HUAWEI TECHNOLOGIES CO., LTD., Shenzhen (CN)

(21) Appl. No.: 19/670,517

(22) Filed: May 7, 2026

Related U.S. Application Data
(63) Continuation of application No. PCT/CN2023/130588, filed on Nov. 9, 2023.

(51) Int. Cl. H04W 24/10; H04L 5/00

(52) U.S. Cl. CPC H04W 24/10; H04L 5/0048

(57) ABSTRACT

Described is an accessing apparatus and a user equipment (UE) apparatus, in which the accessing apparatus is configured to: send a plurality of channel state information reference signal (CSI-RS) configurations to a user equipment (UE); send an activating signalling to the UE to activate a subset of the CSI-RS configurations; and receive a CSI report calculated by the UE based on the subset of CSI-RS configurations at a reporting occasion of the CSI report. In this way, the accessing apparatus is able to access the UE for network energy saving (NES).

### CROSS-REFERENCE TO RELATED APPLICATIONS

This application is a continuation of International Application No. PCT/CN2023/130588, filed on Nov. 9, 2023, the disclosure of which is hereby incorporated by reference in its entirety.

### TECHNICAL FIELD

This application relates to an accessing apparatus and a user equipment (UE) apparatus, and corresponding methods, for active Channel State Information (CSI) resources and active ports counting for network energy saving (NES).

### BACKGROUND

In Rel18, network energy saving (NES) has been studied. NES is currently an important feature in Rel-18. NES may enable the base stations (gNBs) to reduce their power consumption by shutting down of some of the spatial elements (shut down their PA and/or TRXU) and/or power back offs. To achieve accurate shutdown decisions and/or power back offs, the gNBs may rely on using a more advanced and efficient CSI reporting framework that is designed in 3GPP. One of the few remaining issues in Rel18 is how a user equipment (UE) should count the active CSI resources/active ports numbers knowing that it has limited resources available and how to capture this in 3GPP specifications. Using legacy unoptimized counting rules could lead to quick consumption of all the available UE resources, that are reported as part of UE capability, preventing it from reporting more needed reports to have high NES gains.

In RAN1 114 and 114bis meetings, a lot of discussions are focusing on the correct definition of X in TS 38.214 v18.0.0. The definition of X the current version of the specification is not currently set, and this issue is expected to be settled in the RAN1 #115 meeting or after.

An extract of the specification is included below—TS 38.214 v18.0.0:

In any slot, the UE is not expected to have more active Channel State Information Reference Signal (CSI-RS) ports or active CSI-RS resources in active bandwidth parts (BWPs) than reported as capability. Non-zero power (NZP) CSI-RS resource is active in a duration of time defined as follows. For aperiodic CSI-RS, starting from the end of the Physical Downlink Control Channel (PDCCH) containing the request and ending at the end of the scheduled Physical Uplink Shared Channel (PUSCH) containing the report associated with this aperiodic CSI-RS. When the PDCCH candidates are associated with a search space set configured with searchSpaceLinkingId, for the purpose of determining the NZP CSI-RS resource active duration, the PDCCH candidate that ends later in time among the two linked PDCCH candidates is used. For semi-persistent CSI-RS, starting from the end of when the activation command is applied, and ending at the end of when the deactivation command is applied. For periodic CSI-RS, starting when the periodic CSI-RS is configured by higher layer signalling, and ending when the periodic CSI-RS configuration is released.

If a CSI-RS resource is referred N times by one or more CSI Reporting Settings, the CSI-RS resource and the CSI-RS ports within the CSI-RS resource are counted N times.

For a CSI-RS Resource Set for channel measurement configured with two Resource Groups and N Resource Pairs, if a CSI-RS resource is referred X times by one of the M CSI-RS resources, where M is defined in clause 5.2.1.4.2, and/or one or two Resource Pairs, the CSI-RS resource and the CSI-RS ports within the CSI-RS resource are counted X times.

For a CSI report configuration containing sub-configuration(s) indicated in a CSI-ReportConfig, if a CSI-RS resource is referred by M sub-configurations among X sub-configurations, the CSI-RS resource is counted M times and the CSI-RS ports within the CSI-RS resource are counted as follows:

$$max ( {\sum }_{s = 1}^{M} {P}_{s} , P )$$

if each sub-configuration, of the M sub-configurations, is configured with a CSI-RS antenna port subset, provided by [port-subsetIndicator],
M×P if each sub-configuration, of the M sub-configurations, is configured with a list of one or more CSI-RS resources, provided by [nzp-CSI-RS-resourceList], [and/] or is configured with a power offset, provided by [powerOffset].

The correct choice of X could be based on either the CSI-RS type or CSI report type which may highly impact the method at the UE and also highly impact the expected gain of NES.

The following FIGS. 1 to 3 show the active times of A/SP/P CSI RS as specified in TS 38.214 v18.0.0 above.

FIG. 1 is an illustration 100 of an AP CSI-RS active period 104. The active period 104 runs from the DCI 101 to the PUSCH 103. The DCI 101 activates the AP CSI-RS 102.

FIG. 2 is an illustration 200 of a SP CSI-RS active period 204. The active period 204 runs from the activation command 202 to the deactivation command 202. An RRC configuration 203 is sent before the activation command 202, the time between them setting the not active period 205. The SP CSI-RS 201 are activated during the active period 204.

FIG. 3 is an illustration 300 of a P CSI-RS active period 304. The active period 304 runs from the RRC configuration 301 to the RRC release configuration 303. The P CSI-RS 302 are activated during the active period 304.

From CSI processing requirement perspectives, there are two CSI processing metrics: (i) CPU occupancy (counting of simultaneous CPUs); and (ii) Counting of the simultaneously active CSI-RS resources for CSI measurement.

The UE reports, as part of its capabilities, the maximum number of its simultaneous CPUs, denoted as N_CPU. At any given time, assume that there are L CPU occupied, representing the processing units that are in use by ongoing CSI reports. The N_CPU-L unoccupied CPUs can be used to add more CSI reports. Once there are no more unoccupied CPUs available, the UE will not process more CSI. The UE is still required to send CSI report even in this case, but for the CSI requests that are over the limit, the UE is allowed to send outdated reports. Any time a CSI calculation starts, the count L is incremented by O_CPU, where O_CPU is the load designation of the new CSI process, and at any time a CSI calculation ends, the count L is decremented by O_CPU, where O_CPU is the load designation of the completed CSI process.

An extract of the specification is included below—TS 38.214 v18.0.0:

For a CSI report with CSI-ReportConfig with higher layer parameter reportQuantity not set to ‘none’, the CPU(s) are occupied for a number of OFDM symbols as follows:
A periodic or semi-persistent CSI report (excluding an initial semi-persistent CSI report on PUSCH after the PDCCH triggering the report) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of [6, TS 38.213], for the purpose of determining the CPU occupation duration, the PDCCH candidate that ends later in time is used.

For an aperiodic CSI report, the CPU becomes occupied at the end of the last symbol of the PDCCH carrying the CSI trigger and the CPU is released at the end of the last symbol of the PUSCH or PUCCH carrying the report.

For the first report in a sequence of semi-persistent CSI reports on PUSCH, the CPU becomes occupied at the end of the last symbol of the PDCCH activating the CSI process and the CPU is released at the end of the last symbol of the PUSCH carrying the first report.

For periodic and semi-persistent CSI reports, except for the first report in a sequence of semi-persistent CSI reports on PUSCH, the CPU becomes occupied at the latest CSI measurement resource (CSI-RS, CSI-IM or SSB) that is usable for the report and the CPU is released at the end of the last symbol of the PUCCH or PUSCH carrying the report. The latest such CSI resource is formally defined as the latest that is not later than the so-called CSI reference resource. The timing of the CSI reference resource is separately defined. If multiple CSI resources are used for a given report and they do not occur at the same time, then the earliest of those counts.

CPU is not the only quantity describing the UE's processing load though. There is also a separate definition of the UE capability in terms of simultaneously active CSI-RS resources. When determining the number of resources simultaneously active, a different rule than CPU occupancy applies. A CSI resource is considered active for the purposes of determining the number of simultaneously active resources according to the following:

For an aperiodic CSI resource, the CSI resource and the ports within the resource become active at the end of the last symbol of the PDCCH carrying the CSI trigger and the CSI resource becomes inactive at the end of the last symbol of the PUSCH carrying the report.

For a periodic CSI resource, the CSI resource and the ports within the resource become active at the time of the configuration of the CSI resource, and the CSI resource becomes inactive at the time of the release of the CSI resource configuration.

For a semi-persistent CSI resource, the CSI resource and the ports within the resource become active at the time of the activation of the CSI resource, and the CSI resource becomes inactive at the time of the deactivation of the CSI resource.

As it can be seen, for periodic and semi-persistent CSI reports, the CSI measurement resource is considered active much longer than the time of CPU occupancy. The reason for this differentiation is that the count of the simultaneously active CSI resources is a measure of memory use, while the CPU is the measure of processing load.

FIG. 4 is an extract 400 of RAN1 #114bis showing the first counting mode 401, known as Alt 1, and the second counting mode 402, known as Alt 2. Both Alt 1 and Alt2 were discussed in the RAN1 #114bis meeting without reaching an agreement. In more detail:
Issue 8: Counting for active CSI-RS resources and antenna ports
==R1-2310575===
For the X value,
[Huawei, HiSilicon], [CEWiT], [CMCC], [DCM] and [Ericsson] consider that.
   X=N the number of triggered sub-configurations for AP/SP CSI report configuration.
   X=L for P CSI report configuration.
[vivo], [ZTE], [Intel], [Samsung], [CTC], [Apple] and [QC] consider that
X=N for the sub-configurations associated with A-CSI-RS resource(s)
X=L for the sub-configurations associated with SP/P-CSI-RS resource(s)
==R1-2310575===

Many UE vendors claim that Alt2 is the prior art (extension of the legacy spec to NES). For example, in R1-2305349 a company showed that because of Causality problem the ALT2 should be supported. However, on the other hand in R1-2310094 it was shown an example about how quickly Alt2 will lead to saturation in the number of supported sub-configurations which will result in less efficient NES feature.

FIG. 5 is an illustration 500 of an AP or SP reporting 502 on PUSCH 504 with P CSI-RS 501, 503 or SP CSI-RS, 501, 503. When CSI-RS is period or semi-persistent, the UE only measures CSI-RS resources occurring at least Z′ symbols earlier than the first symbol for transmitting PUSCH carrying CSI as illustrated in FIG. 5. Now PDCCH carrying DCI with CSI triggering may not always occur before valid CSI resource for CSI measurement, which requires UE to measure CSI in every CSI-RS resources before PDCCH (which is the reason 3GPP specification specifies that periodic CSI-RS resource is active after it is RRC configured and inactive when it is RRC released, or semi-persistent CSI resource is active after it is activated (MAC-CE) and is inactive after it is deactivated).

FIG. 6 is a table of active resources/ports for the case of a single P=32 port CSI-RS resource referred to by multiple sub-configurations.

FIG. 7 schematically illustrates an exemplary pipeline of SP CSI reporting with P-CSI RS. FIG. 7 shows the disadvantage of Alt2 in the case of SP CSI reporting with P-CSI-RS.

In the example in FIG. 7, the UE is configured with three sub-configurations 703 for Power Domain (PD) adaptation and after some time is triggered to report SP CSI on PUSCH 706 with only two sub-configurations 705. For this case, the number of CPU the UE will use for processing is two. Using ALT2 the UE should count the resource 3 times (which means the UE need to prepare a memory for 3 CPUs). This results in the following problems:

It does not make sense for the UE to continue preparing L=3 memories during time T2, unless the UE is expecting to be trigged with other SP CSI reports or A CSI reports without knowledge when this triggering could happen (gNB+UE solutions may ensure that this will not happen).

It may make sense for the UE to continue preparing L=3 memories during time T1 for spatial domain (SD) adaptation. However, for PD adaptation it does not make sense, since physically what is sent is one resource with three hypothetical power offsets values (gNB indication may be used to inform the UE to start NES memory after triggering for example using an RRC IE or DCI flag).

It is desirable to develop an apparatus and method that overcomes the above problems.

### SUMMARY

According to a first aspect, there is provided an accessing apparatus, the apparatus comprising one or more processors and a memory storing in non-transient form data defining program code executable by the one or more processors, wherein the program code is executable by the one or more processors so that the apparatus is configured to: send a plurality of channel state information reference signal (CSI-RS) configurations to a user equipment (UE); send an activating signalling to the UE to activate a subset of the CSI-RS configurations; and receive a CSI report calculated by the UE based on the subset of CSI-RS configurations at a reporting occasion of the CSI report. In this way, the accessing apparatus is able to configure the UE for NES.

According to a second aspect, there is provided a user equipment (UE) apparatus, the apparatus comprising one or more processors and a memory storing in non-transient form data defining program code executable by the one or more processors, wherein the program code is executable by the one or more processors so that the apparatus is configured to: receive a plurality of channel state information reference signal (CSI-RS) configurations from an accessing apparatus; receive an activating signalling from the accessing apparatus to activate a subset of the CSI-RS configurations; and calculate and send a CSI report based on the subset of CSI-RS configurations at a reporting occasion of the CSI report. In this way, the UE is configured by the accessing apparatus for NES.

In some embodiments, the activating signalling from the accessing apparatus may not be sent during a reporting time period, the reporting time period being defined as the time period between the CSI-RS being sent from the accessing apparatus to the UE until the corresponding reporting occasion of the CSI report. In this way, there may be no ambiguity in resource counting nor in CPUs that will be used for counting.

According to a third aspect, there is provided an accessing apparatus, the apparatus comprising one or more processors and a memory storing in non-transient form data defining program code executable by the one or more processors, wherein the program code is executable by the one or more processors so that the apparatus is configured to: send a plurality of channel state information reference signal (CSI-RS) configurations to a user equipment (UE); send an activating signalling to the UE to activate a subset of the CSI-RS configurations; and not expect to receive a CSI report calculated by the UE based on the subset of CSI-RS configurations at a reporting occasion of the CSI report. In this way, the first reporting can be dropped if a problem similar to the one explained with reference to FIG. 5 occurs.

According to a fourth aspect, there is provided a user equipment (UE) apparatus, the apparatus comprising one or more processors and a memory storing in non-transient form data defining program code executable by the one or more processors, wherein the program code is executable by the one or more processors so that the apparatus is configured to: receive a plurality of channel state information reference signal (CSI-RS) configurations from an accessing apparatus; and report a CSI report to the accessing apparatus only when: the UE receives an activating signalling for activating a subset of CSI-RS configurations before the corresponding reporting occasion of the CSI report; and the UE is able to calculate and report the CSI report to the accessing apparatus based on the subset of CSI-RS configurations before the corresponding reporting occasion of the CSI report. In this way, the first reporting can be dropped if a problem similar to the one explained with reference to FIG. 5 occurs.

According to a fifth aspect, there is provided an accessing apparatus, the apparatus comprising one or more processors and a memory storing in non-transient form data defining program code executable by the one or more processors, wherein the program code is executable by the one or more processors so that the apparatus is configured to: send a plurality of channel state information reference signal (CSI-RS) configurations to a user equipment (UE); send an activating signalling to the UE to activate a subset of the CSI-RS configurations; and receive a CSI report which indicates an unreliable CSI report from the UE when: the UE receives the activating signalling for activating a subset of CSI-RS configurations before a reporting occasion of the CSI report, but the UE is not able to calculate and report the CSI report to the accessing apparatus based on the subset of resource configurations before the corresponding reporting occasion of the CSI report. In this way, the first reporting can indicate if the CSI report is invalid, outdated, or old through the invalid report.

According to a sixth aspect, there is provided a user equipment (UE) apparatus, the apparatus comprising one or more processors and a memory storing in non-transient form data defining program code executable by the one or more processors, wherein the program code is executable by the one or more processors so that the apparatus is configured to: receive a plurality of channel state information reference signal (CSI-RS) configurations from an accessing apparatus; and report a CSI report which indicates an unreliable CSI report to the accessing apparatus when: the UE receives an activating signalling for activating a subset of CSI-RS configurations before a reporting occasion of the CSI report, but the UE is not able to calculate and report the CSI report to the accessing apparatus based on the subset of resource configurations before the corresponding reporting occasion of the CSI report. In this way, the first reporting can indicate if the CSI report is invalid, outdated, or old through the invalid report.

In some embodiments, the subset of the CSI-RS configurations may consist of all, or less than all, the CSI-RS configurations. In this way, the number of CSI-RS configurations that are activated can be varied.

In some embodiments, the activating signalling may be sent by means of downlink control information (DCI) or a medium access control element (MAC CE).

In some embodiments, the accessing apparatus may be configured to send a radio resource control (RRC) activation configuration to the UE, and the UE is configured to receive the RRC activation configuration from the accessing apparatus. In some embodiments, the accessing apparatus may be configured to send a RRC release configuration to the UE, and the UE is configured to receive the RRC release configuration from the accessing apparatus. In some embodiments, the RRC activation configuration may be sent before, or at the same time as, the CSI-RS configurations. In this way, the configuration, activation, and reporting may be carried out during the active period.

In some embodiments, the reporting occasion of the CSI report may be obtained from the DCI, the MAC CE and/or the RRC activation configuration. In this way, the timing of the reporting occasions may be set for all types of reporting.

In some embodiments, the accessing apparatus and the UE may be configured to select to collectively operate in one of the following counting modes: a first counting mode in which counting is based on CSI report types; or a second counting mode in which counting is based on CSI-RS resource types. In this way, the accessing apparatus and the UE may function operate based on different types of counting.

In some embodiments, the accessing apparatus and the UE may be configured to select the first counting mode or the second counting mode for operation in dependence on one or more parameters in the RRC activation configuration. In this way, the RRC activation configuration requirements may be met by the chosen counting mode.

In some embodiments, the accessing apparatus and the UE may be configured to select the first counting mode or the second counting mode for operation in dependence on one or more of: the DCI format, presence of DCI information elements and/or their given values, presence of CSI reporting sub-configuration parameters and/or their given values. In this way, the DCI or the CSI report requirements may be met by the chosen counting mode.

In some embodiments, the accessing apparatus and the UE may be configured to select the first counting mode or the second counting mode for operation in dependence on one or more capabilities of the UE. In this way, the UE requirements may be met by the chosen counting mode.

In some embodiments, a capability of the UE may comprise a maximum number of simultaneous active CSI-RS or active ports that the UE can support per component carrier. In some embodiments, a capability of the UE may comprise a maximum number of simultaneous active CSI-RS or active ports that the UE can support per active bandwidth across all component carriers. In this way, the UE component carrier and bandwidth requirements can be met by the chosen counting mode.

In some embodiments, a capability of the UE may comprise a maximum number of CSI reporting configurations that the UE can be configured with. In some embodiments, a capability of the UE may comprise a maximum number of CSI reporting configurations that the UE can be triggered with. In this way, the CSI report requirements can be met by the chosen counting mode.

In some embodiments, a capability of the UE may comprise the UEs ability to operate in the first counting mode and/or the UEs ability to operate in the second counting mode. In this way, the UEs counting mode requirements can be met by the chosen counting mode.

In some embodiments, the accessing apparatus and the UE may be configured to collectively operate in the first counting mode by default, or the accessing apparatus and the UE are configured to collectively operate in the second counting mode by default. In this way, the counting mode may default to a more efficient counting mode.

In some embodiments, the accessing apparatus and the UE may be configured to collectively select to switch from operating in the first counting mode to the second counting mode. In some embodiments, the accessing apparatus and the UE may be configured to collectively select to switch from operating in the second counting mode to the first counting mode. In this way, the counting mode may be switched to a more efficient counting mode.

According to a seventh aspect, there is provided method comprising operations of: sending a plurality of channel state information reference signal (CSI-RS) configurations to a user equipment (UE); sending an activating signalling to the UE to activate a subset of the CSI-RS configurations; and receiving a CSI report calculated by the UE based on the subset of CSI-RS configurations at a reporting occasion of the CSI report. In this way, the accessing apparatus is able to configure the UE for NES.

According to an eighth aspect, there is provided method comprising operations of: receiving a plurality of channel state information reference signal (CSI-RS) configurations from an accessing apparatus; receiving an activating signalling from the accessing apparatus to activate a subset of the CSI-RS configurations; and calculating and sending a CSI report based on the subset of CSI-RS configurations at a reporting occasion of the CSI report. In this way, the UE is configured by the accessing apparatus for NES.

According to a ninth aspect, there is provided method comprising operations of: send a plurality of channel state information reference signal (CSI-RS) configurations to a user equipment (UE); sending an activating signalling to the UE to activate a subset of the CSI-RS configurations; and not expect to receive a CSI report calculated by the UE based on the subset of CSI-RS configurations at a reporting occasion of the CSI report. In this way, the first reporting can be dropped if a problem similar to the one explained with reference to FIG. 5 occurs.

According to a tenth aspect, there is provided method comprising operations of: receiving a plurality of channel state information reference signal (CSI-RS) configurations from an accessing apparatus; and reporting a CSI report to the accessing apparatus only when: the UE receives an activating signalling for activating a subset of CSI-RS configurations before the corresponding reporting occasion of the CSI report; and the UE is able to calculate and report the CSI report to the accessing apparatus based on the subset of CSI-RS configurations before the corresponding reporting occasion of the CSI report. In this way, the first reporting can be dropped if a problem similar to the one explained with reference to FIG. 5 occurs.

According to a eleventh aspect, there is provided method comprising operations of: sending a plurality of channel state information reference signal (CSI-RS) configurations to a user equipment (UE); sending an activating signalling to the UE to activate a subset of the CSI-RS configurations; and receiving a CSI report which indicates an unreliable CSI report from the UE when: the UE receives the activating signalling for activating a subset of CSI-RS configurations before a reporting occasion of the CSI report, but the UE is not able to calculate and report the CSI report to the accessing apparatus based on the subset of resource configurations before the corresponding reporting occasion of the CSI report. In this way, the first reporting can indicate if the CSI report is invalid, outdated, or old through the invalid report.

According to a twelfth aspect, there is provided method comprising operations of: receiving a plurality of channel state information reference signal (CSI-RS) configurations from an accessing apparatus; and reporting a CSI report which indicates an unreliable CSI report to the accessing apparatus when: the UE receives an activating signalling for activating a subset of CSI-RS configurations before a reporting occasion of the CSI report, but the UE is not able to calculate and report the CSI report to the accessing apparatus based on the subset of resource configurations before the corresponding reporting occasion of the CSI report. In this way, the first reporting can indicate if the CSI report is invalid, outdated, or old through the invalid report.

### BRIEF DESCRIPTION OF THE FIGURES

The present disclosure will now be described by way of example with reference to the accompanying drawings. In the drawings:

FIG. 1 is an illustration of an AP CSI-RS active period.

FIG. 2 is an illustration of a SP CSI-RS active period.

FIG. 3 is an illustration of a P CSI-RS active period.

FIG. 4 is an extract of RAN1 #114bis showing the first counting mode and the second counting mode.

FIG. 5 is an illustration of an AP or SP reporting on PUSCH with P CSI-RS or SP CSI-RS.

FIG. 6 is a table of active resources/ports for the case of a single P=32 port CSI-RS resource referred to by multiple sub-configurations.

FIG. 7 schematically illustrates an exemplary pipeline of SP CSI reporting with P-CSI RS used in the present system.

FIG. 8A shows an example of a first computer implemented method for accessing a UE from the accessing apparatus side. FIG. 8B shows an example of the first computer implemented method for accessing a UE from the UE side.

FIG. 9A shows an example of a second computer implemented method for accessing a UE from the accessing apparatus side. FIG. 9B shows an example of the second computer implemented method for accessing a UE from the UE side.

FIG. 10A shows an example of a third computer implemented method for accessing a UE from the accessing apparatus side. FIG. 10B shows an example of the third computer implemented method for accessing a UE from the UE side.

FIG. 11 shows an example of an accessing apparatus and a UE configured to perform the methods described herein.

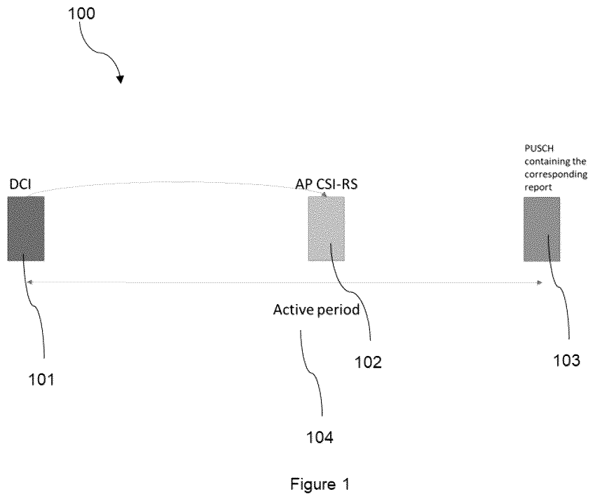

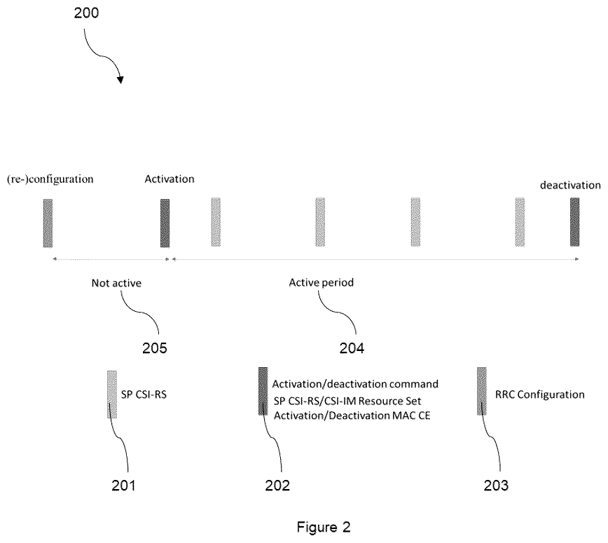

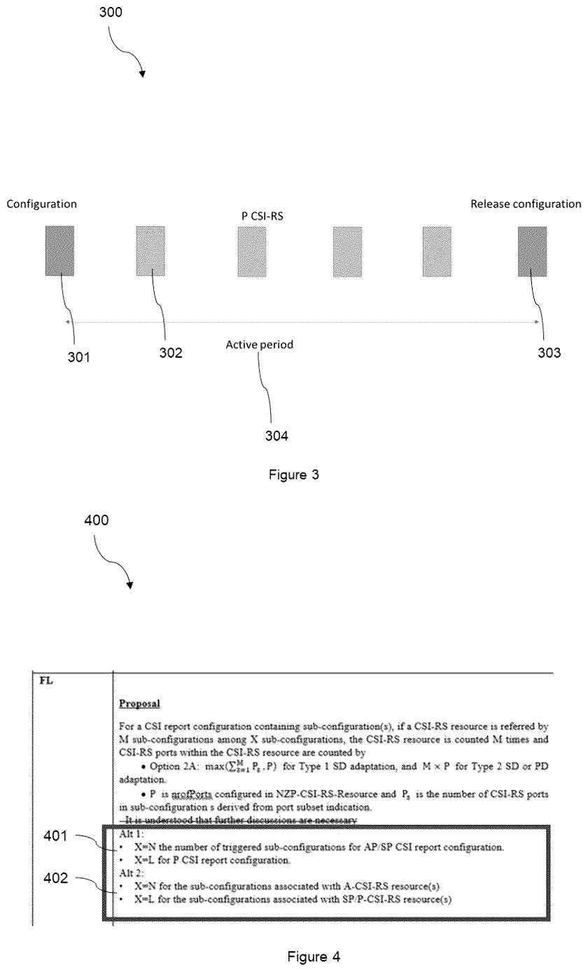

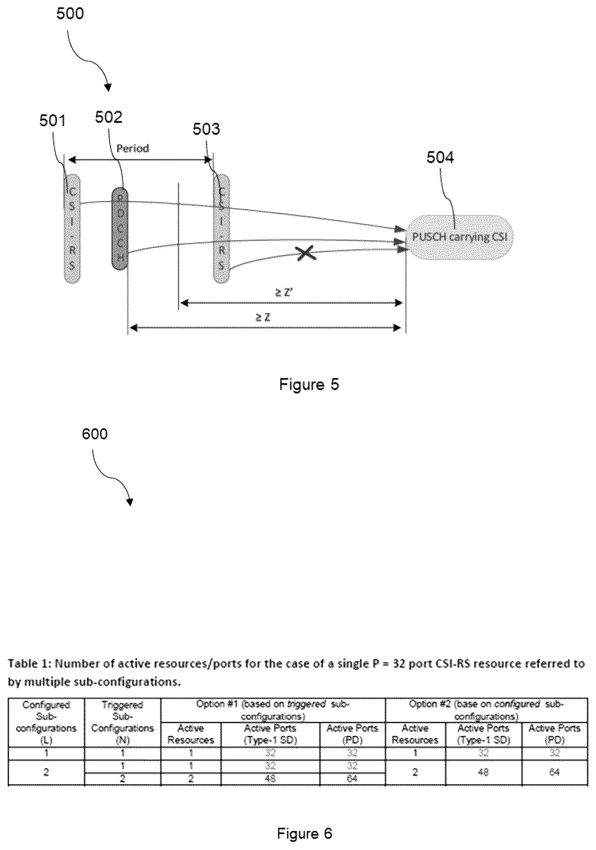

### DETAILED DESCRIPTION

The apparatuses and methods described herein concern the accessing of a UE by a by CSI resource and active ports counting for network energy saving (NES).

Embodiments of the present disclosure may tackle one or more of the problems previously mentioned by: receiving a CSI report calculated by the UE based on the subset of CSI-RS configurations at a reporting occasion of the CSI report. In this way, the accessing apparatus 1100 is able to access the UE 1110 for network energy saving (NES).

The following terms may be used throughout the application:

| | |
|---|---|
| Long Term Evolution | (LTE) |
| 5th generation mobile networks | (5G) |
| User Equipment | (UE) |
| Radio Resource Control | (RRC) |
| New Radio | (NR) |
| Transmission Reception Point | (TRP) |
| Physical Uplink Control Channel | (PUCCH) |
| Physical Uplink Shared Channel | (PUSCH) |
| Physical Downlink Control Channel | (PDCCH) |
| Physical Downlink Shared Channel | (PDSCH) |
| Medium Access Control | (MAC) |
| MAC Control Element | (MAC CE) |
| Discontinuous Reception | (DRX) |
| Downlink Control Information | (DCI) |
| Semi Persistent Scheduling | (SPS) |
| Hybrid Automatic Repeat reQuest | (HARQ) |
| Configured Grant | (CG) |
| Dynamic Grant | (DG) |
| Aperiodic | (AP) |
| Semi-Persistent | (SP) |
| Spatial Domain | (SD) |
| Periodic | (P) |
| Power Domain | (PD) |
| Channel State Information | (CSI) |
| Network Energy Saving | (NES) |

The present system may aim to solve the following problem. How to take into consideration the implementation of legacy UEs (which may be based on Alt2) and at the same time enable an efficient NES scheme which simplifies the UE implementation in terms of using the memory.

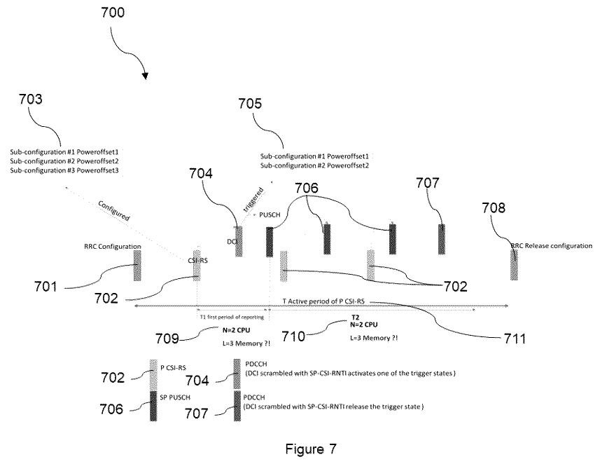

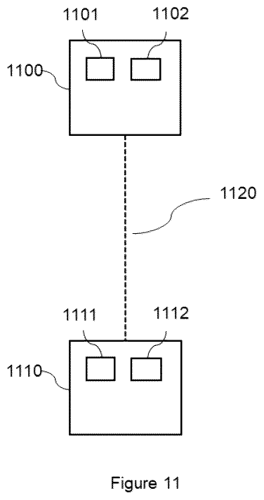

FIG. 7 schematically illustrates an exemplary pipeline 700 of SP CSI reporting with P-CSI RS used in the present system. The pipeline 700 may be applied to an accessing apparatus 1100, such as a gNB, and a user equipment (UE) apparatus 1110—see FIG. 11. The present system may aim to solve the aforementioned problems by means of three general embodiments.

### Embodiment 1

A plurality of channel state information reference signal (CSI-RS) configurations 703 may be sent from the accessing apparatus 1100. The plurality of CSI-RS configurations 703 may be sent to the UE 1110. Each of the plurality of CSI-RS configurations 703 may have been generated by a CSI-RS resource 702. The CSI-RS resource 702 may configure the CSI-RS configurations 703. In the example shown in FIG. 7, there are three CSI-RS configurations 703. A different number of CSI-RS configurations 703 may also be suitable. In the example shown in FIG. 7, the CSI-RS configurations 703 are used for poweroffset.

An activating signalling 704 may be sent from the accessing apparatus 1100. The activating signalling 704 may be sent to the UE 1110. The activating signalling may active a subset 705 of the CSI-RS configurations 703. The subset 705 may comprise less than all of the CSI-RS configurations 703. In the example shown in FIG. 7, there are two CSI-RS configurations 703 in the subset 705. A different number in the subset may also be suitable. For example, the subset 705 may comprise all of the CSI-RS configurations 703. In other words, the number in the subset 705 may be equal to the number of CSI-RS configurations 703. Activating the subset 705 of the CSI-RS configurations 703 may initiate the running of the subset 705 of the CSI-RS configurations 703.

A CSI report 706 may be calculated by the UE 1110. The CSI report 706 may be based on the subset 705 of CSI-RS configurations 703. The CSI report 706 may include details about the activated subset 705 of CSI-RS configurations 703. The CSI report 706 may be sent from the UE 1110. The CSI report 706 may be received by the accessing apparatus 1100. The CSI report 706 may be sent and received at a reporting occasion of the CSI report 706. In this way, the accessing apparatus 1100 is able to access the UE 1110 for NES.

The time between the CSI-RS resource 702 configuring the CSI-RS configurations 703 and the CSI report 706 being sent, i.e., the reporting occasion, may be known as a reporting time period 709. In some embodiments of Embodiment 1, the activating signalling 704 may not be sent during the reporting time period 709. The activating signalling 704 may be sent after the CSI report 706 is sent, i.e., the reporting occasion. In this case, the CSI report 706 may be based on an inactive subset 705 of the CSI-RS configurations 703. In this way, there may be no ambiguity in resource counting nor in CPUs that will be used for counting.

### Embodiment 2

A plurality of channel state information reference signal (CSI-RS) configurations 703 may be sent from the accessing apparatus 1100. The plurality of CSI-RS configurations 703 may be sent to the UE 1110. Each of the plurality of CSI-RS configurations 703 may have been generated by a CSI-RS resource 702. The CSI-RS resource 702 may configure the CSI-RS configurations 703. In the example shown in FIG. 7, there are three CSI-RS configurations 703. A different number of CSI-RS configurations 703 may also be suitable. In the example shown in FIG. 7, the CSI-RS configurations 703 are used for poweroffset.

An activating signalling 704 may be sent from the accessing apparatus 1100. The activating signalling 704 may be sent to the UE 1110. The activating signalling may active a subset 705 of the CSI-RS configurations 703. The subset 705 may comprise less than all the CSI-RS configurations 703. In the example shown in FIG. 7, there are two CSI-RS configurations 703 in the subset 705. A different number in the subset may also be suitable. For example, the subset 705 may comprise all of the CSI-RS configurations 703. In other words, the number in the subset 705 may be equal to the number of CSI-RS configurations 703. Activating the subset 705 of the CSI-RS configurations 703 may initiate the running of the subset 705 of the CSI-RS configurations 703.

A CSI report 706 may be calculated by the UE 1110. The CSI report 706 may be based on the subset 705 of CSI-RS configurations 703. The CSI report 706 may include details about the activated subset 705 of CSI-RS configurations 703.

In this embodiment, the accessing apparatus 1100 may be configured to not expect to receive a CSI report 706. In particular, the accessing apparatus 1100 will not expect to receive a CSI report 706 calculated by the UE 1110 based on the subset 705 of CSI-RS configurations 703 at the reporting occasion of the CSI report 706. In this way, the first reporting can be dropped if there is a lack of information. In Embodiment 2, the accessing apparatus 1100 can use the resources not used by the UE 1110 reporting for other purposes, e.g., schedule reporting or data for other UEs.

The CSI report 706 may only be sent from the UE 1110 to the accessing apparatus 1100 when both of the following criteria are met: (1) The UE 1100 has received the activating signalling 704 for activating the subset 705 of CSI-RS configurations 703 before the corresponding reporting occasion of the CSI report 706—in other words, the activating signalling 704 is received before the CSI report 706 would have been sent; and (2) The UE 1110 is able to calculate and report the CSI report 706 to the accessing apparatus 1100 based on the subset 705 of CSI-RS configurations 703 before the corresponding reporting occasion of the CSI report 706—in other words, the UE is unable to calculate the CSI report 706 before the CSI report 706 should have been sent. In this way, the first reporting can be dropped if there is a lack of information.

### Embodiment 3

A plurality of channel state information reference signal (CSI-RS) configurations 703 may be sent from the accessing apparatus 1100. The plurality of CSI-RS configurations 703 may be sent to the UE 1110. Each of the plurality of CSI-RS configurations 703 may have been generated by a CSI-RS resource 702. The CSI-RS resource 702 may configure the CSI-RS configurations 703. In the example shown in FIG. 7, there are three CSI-RS configurations 703. A different number of CSI-RS configurations 703 may also be suitable. In the example shown in FIG. 7, the CSI-RS configurations 703 are used for poweroffset.

An activating signalling 704 may be sent from the accessing apparatus 1100. The activating signalling 704 may be sent to the UE 1110. The activating signalling may active a subset 705 of the CSI-RS configurations 703. The subset 705 may comprise less than all the CSI-RS configurations 703. In the example shown in FIG. 7, there are two CSI-RS configurations 703 in the subset 705. A different number in the subset may also be suitable. For example, the subset 705 may comprise all of the CSI-RS configurations 703. In other words, the number in the subset 705 may be equal to the number of CSI-RS configurations 703. Activating the subset 705 of the CSI-RS configurations 703 may initiate the running of the subset 705 of the CSI-RS configurations 703.

A CSI report 706 may be calculated by the UE 1110. The CSI report 706 may be based on the subset 705 of CSI-RS configurations 703. The CSI report 706 may include details about the activated subset 705 of CSI-RS configurations 703.

In this embodiment, an unreliable CSI report 706 may be sent from the UE 1110 to the accessing apparatus 1100 when both of the following criteria are met: (1) the UE 1110 receives the activating signalling 704 for activating a subset 705 of CSI-RS configurations 703 before a reporting occasion of the CSI report 706—in other words, the activating signalling 704 is received before the CSI report 706 would have been sent; but (2) the UE 1110 is not able to calculate and report the CSI report 706 to the access apparatus 1100 based on the subset 705 of CSI-RS configurations before the corresponding reporting occasion of the CSI report 706—in other words, the UE 1110 is unable to calculate the CSI report 706 before the CSI report 706 should have been sent. In this way, the first reporting can indicate, through the unreliable CSI report 706, if there is a lack of information. The unreliable CSI report 706 may be due to an invalid CSI report 706. The unreliable CSI report 706 may be due to an outdated CSI report 706. The unreliable CSI report 706 may be due to an old CSI report 706.

### All Embodiments

The following features may apply to any of the embodiments:

The accessing apparatus 1100 may send an RRC activation configuration 701. The accessing apparatus 1100 may send the RRC activation configuration 701 to the UE 1110. The UE 1110 may receive the RRC activation configuration. The RRC activation configuration 701 may initiate the active period 711. During the active period, the subset 705 of CSI-RS configurations 703 may be activated, and the CSI reports 704 may be sent. The RRC activation configuration 701 may be sent before the CSI-RS configurations 703 are configured by the CSI-RS 702—this is illustrated in the example in FIG. 7. Alternatively, the RRC activation configuration 701 may be sent at the same time as the CSI-RS configurations 703 are configured by the CSI-RS 702.

The accessing apparatus 1100 may send an RRC release configuration 708. The accessing apparatus 1100 may send the RRC release configuration 708 to the UE 1110. The UE 1110 may receive the RRC release configuration 708. The RRC release configuration 708 may end the active period 711.

Further CSI-RS configurations 703 may be sent from the accessing apparatus 1100 to the UE 1110. The further CSI-RS configurations 703 may have been generated by a further CSI-RS resource 702. Each of the further CSI-RS configurations 703 may be generated and sent in the active period 711. There are two further CSI-RS resources 702 shown in FIG. 7.

The activating signalling 704 may be sent by means of downlink control information (DCI) 704—this is illustrated in the example in FIG. 7. Alternatively, the activating signalling 704 may be sent by means of a medium access control element (MAC CE). The DCI 704 or MAC CE may include instructions or permissions for the subset 705 of CSI-RS configurations 703 to be activated. The DCI 704 may be scrambled with SP-CSI-RNTI to activate one of the trigger states by means of a physical downlink control channel (PDCCH)—this is illustrated in the example in FIG. 7.

A final activating signalling 707 may be sent by means of DCI—this is illustrated in the example in FIG. 7. The final DCI 707 may include instructions or permissions for the subset 705 of CSI-RS configurations 703 to be released. The final DCI 707 may be scrambled with SP-CSI-RNTI to release the trigger states by means of a physical downlink control channel (PDCCH)—this is illustrated in the example in FIG. 7.

The CSI report 706 may be sent by means of a physical uplink shared channel (PUSCH) 706—this is illustrated in the example in FIG. 7. Alternatively, the CSI report 706 may be sent by means of a physical uplink control channel (PUCCH). The PUSCH 706 or PUCCH may include information about the activated subset 705 of CSI-RS configurations 703.

Further CSI reports 706 may be sent from the accessing apparatus 1100 to the UE 1110. The further CSI reports 706 may have been generated based on the subset 705 of the further CSI-RS configurations 703. Each of the further CSI reports 706 may be calculated and sent in the active period 711. There are two further CSI reports 706 shown in FIG. 7.

The reporting occasion may define when the CSI report 706 is sent. There may be a plurality of reporting occasions during the active period 711 for the CSI report 706 and further CSI reports 706. The reporting occasion of the CSI report 706 may be obtained from the DCI 704. The DCI 704 may be used for aperiodic reporting. The reporting occasion of the CSI report 706 may be obtained from the MAC CE. The MAC CE may be used for semi persistent reporting. The reporting occasion of the CSI report 706 may be obtained from the RRC activation configuration 701. The RRC activation configuration 701 may be used for periodic reporting. In this way, the timing of the reporting occasions may be set for all types of reporting.

The accessing apparatus 1100 and the UE 1110 may be configured to select to collectively operate in one of the following counting modes: (i) a first counting mode 401 in which counting is based on CSI report types; or (ii) a second counting mode 402 in which counting is based on CSI-RS resource types. The first counting mode 401 may be based on Alt 1 in FIG. 4. The second counting mode 402 may be based on Alt 2 in FIG. 4. In this way, the accessing apparatus 1100 and the UE 1110 may function operate based on different types of counting.

The selection of the counting mode may be in dependence on any of the following selection criteria, alone or in combination:

The selection of the first counting mode 401 or the second counting mode 402 may be in dependence on one or more parameters in the RRC activation configuration 701. Parameters in the RRC activation configuration 701 may require a counting mode to be chosen. In this way, the RRC activation configuration 701 requirements may be met by the chosen counting mode. Alternatively, or in addition, the selection of the first counting mode 401 or the second counting mode 402 may be in dependence on one or more of: the DCI format, presence of DCI information elements and/or their given values, presence of CSI reporting sub-configuration parameters and/or their given values. Parameters in the DCI 704 or the CSI reports 706 may require a counting mode to be chosen. In this way, the DCI 704, or the CSI report 706 requirements may be met by the chosen counting mode.

Alternatively, or in addition, the selection of the first counting mode 401 or the second counting mode 402 may be in dependence on one or more capabilities of the UE 1110. The capabilities of the UE 1110 may require a counting mode to be chosen. In this way, the UE 1110 requirements may be met by the chosen counting mode.

A capability of the UE 1110 may include a maximum number of simultaneous active CSI-RS/active ports numbers that the UE 1110 can support per component carrier. A capability of the UE 1110 may include a maximum number of simultaneous active/active ports numbers CSI-RS that the UE 1110 can support per active bandwidth across all component carriers. In this way, the UE 1110 component carrier and bandwidth requirements can be met by the chosen counting mode.

A capability of the UE 1110 may include a maximum number of CSI reporting configurations that the UE 1110 can be configured with. A capability of UE 1110 may include a maximum number of CSI reporting configurations that the UE 1110 can be triggered with. In this way, the CSI report 706 requirements can be met by the chosen counting mode.

A capability of the UE 1110 may include the UEs 1110 ability to operate in the first counting mode 401. A capability of the UE 1110 may include the UEs 1110 ability to operate in the second counting mode 402. In this way, the UEs 1110 counting mode requirements can be met by the chosen counting mode.

The accessing apparatus 1100 and the UE 1110 may be configured to collectively operate in the first counting mode 401 by default. Alternatively, the accessing apparatus 1100 and the UE 1110 may be configured to collectively operate in the second counting mode 402 by default. The selected counting mode may be predefined. In this way, the counting mode may default to a more efficient counting mode.

The accessing apparatus 1100 and the UE 1110 may be configured to collectively select to switch from operating in the first counting mode 401 to the second counting mode 402. The accessing apparatus 1100 and the UE 1110 may be configured to collectively select to switch from operating in the second counting mode 402 to the first counting mode 401. If the first counting mode 401 is the default, then the accessing apparatus 1100 and the UE 1110 may switch to the second counting mode 402. If the second counting mode 402 is the default, then the accessing apparatus 1100 and the UE 1110 may switch to the first counting mode 401. The switch may occur as a result of any of the selection criteria described herein. In particular, the switch may occur after the first CSI report 706. In this way, the counting mode may be switched to a more efficient counting mode.

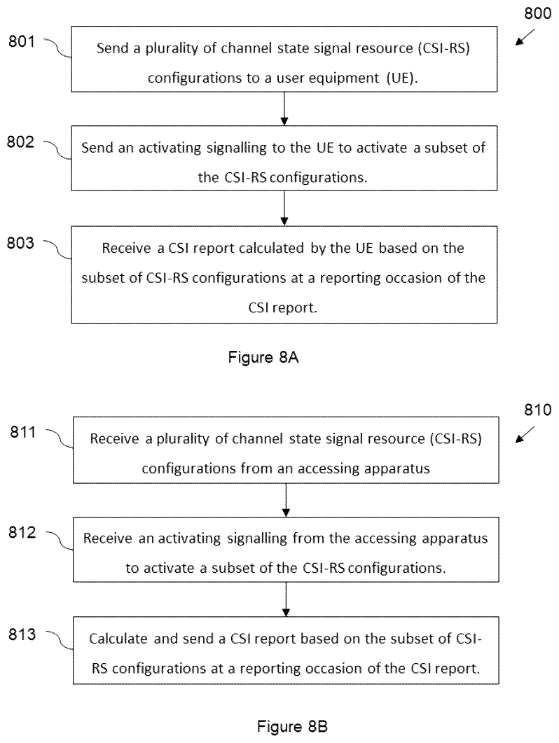

FIG. 8A summarises an example of a method 800 for accessing a UE. At operation 801, the method 800 comprises sending a plurality of channel state information reference signal (CSI-RS) configurations to a user equipment (UE). At operation 802, the method 800 comprises sending an activating signalling to the UE to activate a subset of the CSI-RS configurations. At operation 803, the method 800 comprises receiving a CSI report calculated by the UE based on the subset of CSI-RS configurations at a reporting occasion of the CSI report.

FIG. 8B summarises an example of a method 810 for accessing a UE. At operation 811, the method 810 comprises receiving a plurality of channel state information reference signal (CSI-RS) configurations from an accessing apparatus. At operation 812, the method 810 comprises receiving an activating signalling from the accessing apparatus to activate a subset of the CSI-RS configurations. At operation 813, the method 810 comprises calculating and send a CSI report based on the subset of CSI-RS configurations at a reporting occasion of the CSI report.

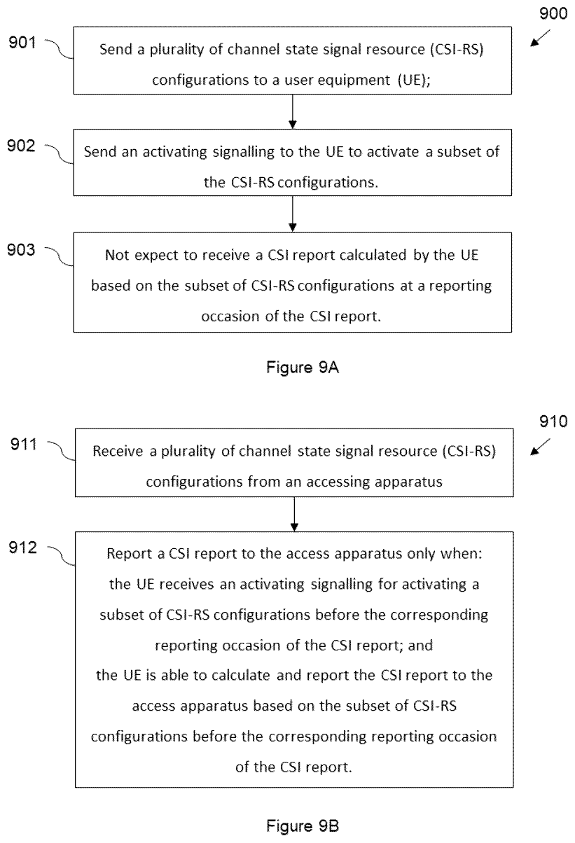

FIG. 9A summarises an example of a method 900 for accessing a UE. At operation 901, the method 900 comprises sending a plurality of channel state information reference signal (CSI-RS) configurations to a user equipment (UE). At operation 902, the method 900 comprises sending an activating signalling to the UE to activate a subset of the CSI-RS configurations. At operation 903, the method 900 comprises not expecting to receive a CSI report calculated by the UE based on the subset of CSI-RS configurations at a reporting occasion of the CSI report.

FIG. 9B summarises an example of a method 910 for accessing a UE. At operation 911, the method 910 comprises receiving a plurality of channel state information reference signal (CSI-RS) configurations from an accessing apparatus. At operation 912, the method 910 comprises reporting a CSI report to the accessing apparatus only when: the UE receives an activating signalling for activating a subset of CSI-RS configurations before the reporting occasion of the CSI report; and the UE is able to calculate and report the CSI report to the accessing apparatus based on the subset of CSI-RS configurations before the reporting occasion of the CSI report.

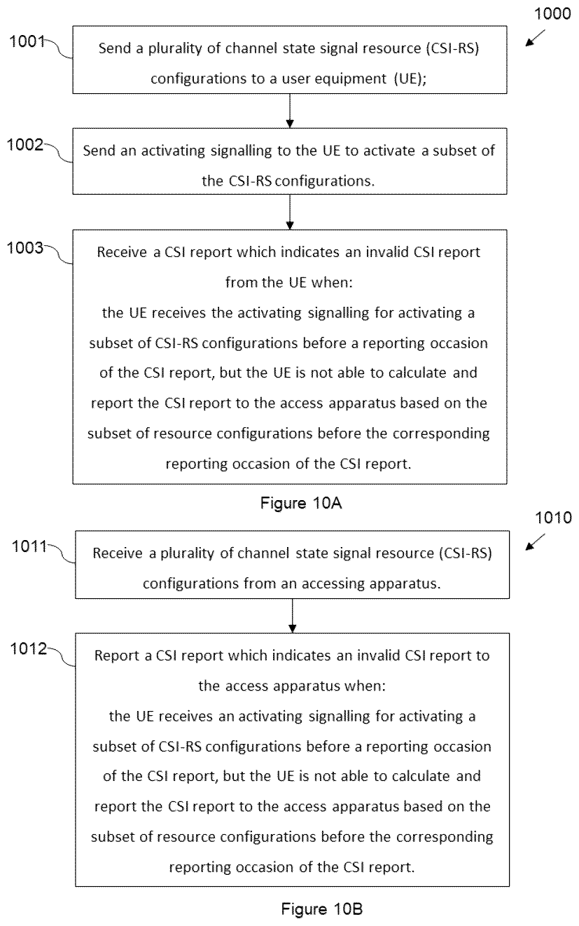

FIG. 10A summarises an example of a method 1000 for accessing a UE. At operation 1001, the method 1000 comprises sending a plurality of channel state information reference signal (CSI-RS) configurations to a user equipment (UE). At operation 1002, the method 1000 comprises sending an activating signalling to the UE to activate a subset of the CSI-RS configurations. At operation 1003, the method 1000 comprises receiving a CSI report which indicates an unreliable CSI report from the UE when: the UE receives the activating signalling for activating a subset of CSI-RS configurations before the reporting occasion of the CSI report, but the UE is not able to calculate and report the CSI report to the accessing apparatus based on the subset of resource configurations before the reporting occasion of the CSI report.

FIG. 10B summarises an example of a method 1010 for accessing a UE. At operation 1011, the method 1010 comprises receiving a plurality of channel state information reference signal (CSI-RS) configurations from an accessing apparatus. At operation 1012, the method 1010 comprises reporting a CSI report which indicates an unreliable CSI report to the accessing apparatus when: the UE receives an activating signalling for activating a subset of CSI-RS configurations before the reporting occasion of the CSI report, but the UE is not able to calculate and report the CSI report to the accessing apparatus based on the subset of resource configurations before the reporting occasion of the CSI report.

An example of accessing apparatus 1100 configured to implement the methods 800, 900 and 1000 is schematically illustrated in FIG. 11. The accessing apparatus 1100 may implement the pipeline 700. The accessing apparatus 1100 may be implemented on an electronic device, such as a computer, laptop, tablet, or smart phone. An example of UE 1110 configured to implement the methods 810, 910 and 1010 is schematically illustrated in FIG. 11. The UE 1110 may implement the pipeline 700. The UE 1110 may be implemented on an electronic device, such as a computer, laptop, tablet, or smart phone. The accessing apparatus 1100 and the UE 1110 may be connected by a connection 1120. The connection 1120 may comprise a network connection 1120, such as the internet or Wi-Fi.

The accessing apparatus 1100 and the UE apparatus 1110 comprises a processor 1101, 1111 configured to process the datasets in the manner described herein. For example, the processor 1101, 1111 may be implemented as a computer program running on a programmable device such as a Central Processing Unit (CPU). The apparatus 1100, 1110 comprises a memory 1102, 1112 which is arranged to communicate with the processor 1101, 1111. Memory 1102, 1112 may be a non-volatile memory. The processor 1101, 1111 may also comprise a cache (not shown in FIG. 11), which may be used to temporarily store data from memory 1102, 1112. The apparatus 1100, 1110 may comprise more than one processor 1101, 1111 and more than one memory 1102, 1112. The memory 1102, 1112 may store data that is executable by the processor 1101, 1111. The processor 1101, 1111 may be configured to operate in accordance with a computer program stored in non-transitory form on a machine-readable storage medium. The computer program may store instructions for causing the processor to perform its methods in the manner described herein. The method operations described herein may be carried out by a computer-readable storage medium. The method operations described herein may be carried out by a computer program product.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description, it will be evident to a person skilled in the art that various modifications may be made within the scope of the disclosure.

1. A communication method, comprising:
receiving a plurality of channel state information reference signal (CSI-RS) configurations;
receiving an activating signalling from an accessing apparatus, the activating signalling is used to activate a subset of the CSI-RS configurations;
calculating a CSI report based on the subset of CSI-RS configurations at a reporting occasion; and
sending the CSI report.

2. The communication method according to claim 1, wherein the activating signalling is not sent during a reporting time period, the reporting time period being defined as a time period between the CSI-RS being sent to a user equipment (UE) until a corresponding reporting occasion of the CSI report.

3. The communication method according to claim 1, wherein the CSI-RS configurations are used for poweroffset.

4. The communication method according to claim 1, wherein the subset of the CSI-RS configurations comprises at least a part of the plurality of CSI-RS configurations.

5. The communication method according to claim 1, wherein activating signalling is sent after the CSI report.

6. The communication method according to claim 5, wherein there is no ambiguity in resource counting nor in central processing units (CPUs) that will be used for calculating the CSI report.

7. A communication method, comprising:
sending a plurality of channel state information reference signal (CSI-RS) configurations to a user equipment (UE);
sending an activating signalling to the UE to activate a subset of the CSI-RS configurations; and
receiving a CSI report calculated by the UE based on the subset of CSI-RS configurations at a reporting occasion of the CSI report.

8. The communication method s according to claim 7, wherein the activating signalling is not sent during a reporting time period, the reporting time period being defined as a time period between the CSI-RS being sent to the UE until a corresponding reporting occasion of the CSI report.

9. The communication method according to claim 7, wherein the CSI-RS configurations are used for poweroffset.

10. The communication method according to claim 7, wherein the subset of the CSI-RS configurations comprises at least a part of the plurality of channel state information reference signal (CSI-RS) configurations.

11. The communication method according to claim 7, wherein activating signalling is sent after the CSI report.

12. The communication method according to claim 11, wherein there is no ambiguity in resource counting nor in central processing units (CPUs) that will be used for calculating the CSI report.

13. An accessing apparatus, comprising:
a memory storing instructions; and
one or more processors, wherein the one or more processors are configured to execute the instructions that cause the apparatus to:
receive a plurality of channel state information reference signal (CSI-RS) configurations;
receive an activating signalling from the accessing apparatus, the activating signalling is used to activate a subset of the CSI-RS configurations;
calculate a CSI report based on the subset of CSI-RS configurations at a reporting occasion; and
sending the CSI report.

14. The accessing apparatus according to claim 13, wherein the activating signalling is not sent during a reporting time period, the reporting time period being defined as the time period between the CSI-RS being sent to a user equipment (UE) until a corresponding reporting occasion of the CSI report.

15. The accessing apparatus according to claim 13, wherein the CSI-RS configurations are used for poweroffset.

16. The accessing apparatus according to claim 13, wherein the subset of the CSI-RS configurations comprises at least a part of the plurality of CSI-RS configurations.

17. The accessing apparatus according to claim 13, wherein activating signalling is sent after the CSI report.

18. The accessing apparatus according to claim 17, wherein there is no ambiguity in resource counting nor in central processing units (CPUs) that will be used for calculating the CSI report.
